(19) United States
(12) Patent Application Publication
(10) Pub. No.: US 2013/0262563 A1
(43) Pub. Date: Oct. 3, 2013

(54) INTERNET ACCESS SYSTEM AND METHOD

(71) Applicant: CHENG-HUANG LU, Shenzhen City (CN)

(72) Inventor: CHENG-HUANG LU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/564,732

(22) Filed: Aug. 2, 2012

(30) Foreign Application Priority Data
Mar. 29, 2012 (CN) 201210087156.9

(51) Int. Cl. G06F 15/16

(52) U.S. Cl. 709/203

(57) ABSTRACT

An exemplary embodiment internet access method transmits a request through a first communication unit to a second communication unit in response to user request for a target web page. The method then analyzes the request to obtain an internet address of the target web page. Next, the method accesses the target web page on an internet server according to the internet address through the third communication unit, obtains source code of the target web page from the internet server, and transmits the obtained source code through the second communication unit to the first communication unit. Then, the method generates a web page according to the source code from the first communication unit. Next, the method controls the display unit to display the generated web page.

### BACKGROUND

1. Technical Field

The present disclosure relates to internet access systems, and particularly, to an internet access system capable of assisting a portable computer to access internet through a mobile device and a method for accessing internet.

2. Description of Related Art

Electronic devices, such as computers, can access a web page through a cable network. However, when a cable network is not available, and no wireless network card is installed, it is difficult for a user to access a web page. Although a mobile device does not depend on the wireless network card and can wirelessly access a web page, the display unit of the mobile device is small, which may be inconvenient to view the web page. Therefore, it is desirable to provide an internet access system to resolve the above problems.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a schematic diagram illustrating an internet access system in accordance with an exemplary embodiment.

FIG. 2 is a block diagram showing a computer in accordance with an exemplary embodiment.

FIG. 3 is a block diagram showing a mobile device in accordance with an exemplary embodiment.

FIG. 4 is a flowchart of an internet access method in accordance with an exemplary embodiment.

### DETAILED DESCRIPTION

The embodiments of the present disclosure are described with reference to the accompanying drawings.

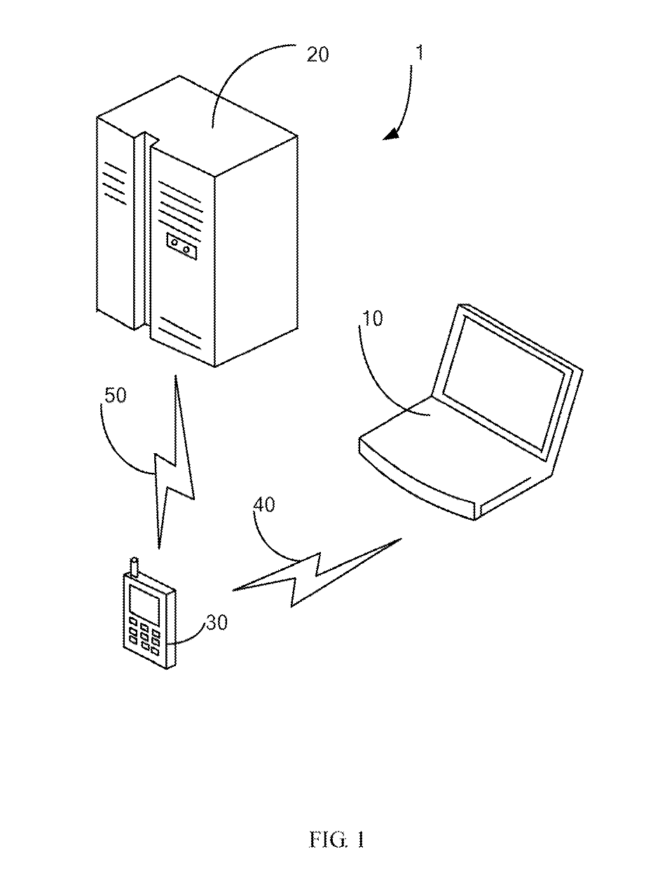

FIG. 1 is a schematic diagram illustrating an internet access system 1 that allows a computer 10 to visit an internet server 20 through a mobile device 30. The internet access system 1 includes the computer 10 and the mobile device 30. The computer 10 can communicate with the mobile device 30 through a first network 40. In the embodiment, the first network 40 is a Bluetooth network or Wi-Fi network. The mobile device 30 can visit the internet server 20 through a second network 50. In the embodiment, the second network 50 is a global system for mobile communications network, a code division multiple access network, or a third generation network. In response to a user request for a target web page, the computer 10 transmits the request to the mobile device 30 through the first network 40. The mobile device 30 then accesses the internet server 20 through the second network 50 to obtain source code of the target web page from the internet server 20 according to the received request, and transmits the obtained source code to the computer 10.

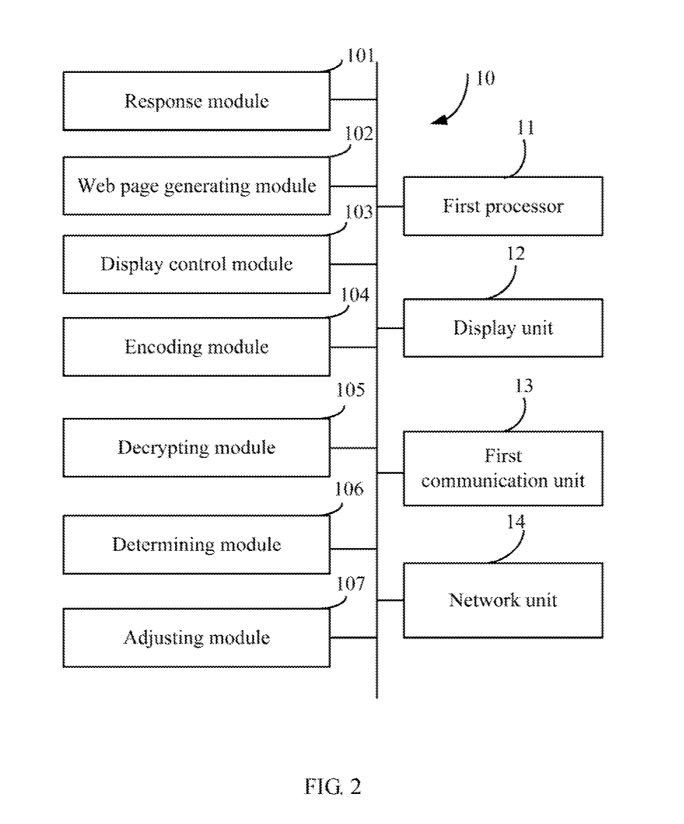

FIG. 2 shows a block diagram of the computer 10 in accordance with an exemplary embodiment. The computer 10 includes a first processor 11, a display unit 12, a first communication unit 13, a response module 101, a web page generating module 102, and a display control module 103. The first communication unit 13 can communicate with the mobile device 30 through the first network 40.

The response module 101 is operable to transmit a request to the mobile device 30 through the first communication unit 13 in response to a user request for a target web page. The web page generating module 102 is operable to receive source code of the target web page from the mobile device 30 through the first communication unit 13, and generate a web page according to the source code. The display control module 103 is operable to control the display unit 12 to display the generated web page.

In the embodiment, the computer 10 further includes an encoding module 104 and a decrypting module 105. Before the response module 101 transmits the request to the mobile device 30 through the first communication unit 13, the encoding module 104 encodes the request. And before the web page generating module 102 generates the web page, the decrypting module 105 decrypts the received source code.

In the embodiment, the computer 10 further includes a network unit 14 and a determining module 106. The network unit 14 communicates with the internet server 20 through the second network 50. The determining module 106 is operable to determine whether the second network 50 is available. If the second network 50 is available, the response module 101 is operable to directly access the internal server 20 through the network unit 14, to obtain the source code of the target web page. Otherwise, the response module 101 is operable to transmit the request to the mobile device 30 through the first communication unit 13.

In the embodiment, the computer 10 further includes an adjusting module 107. The adjusting module 107 is operable to adjust the aspect ratio of the web page, the size of the web page, and so on.

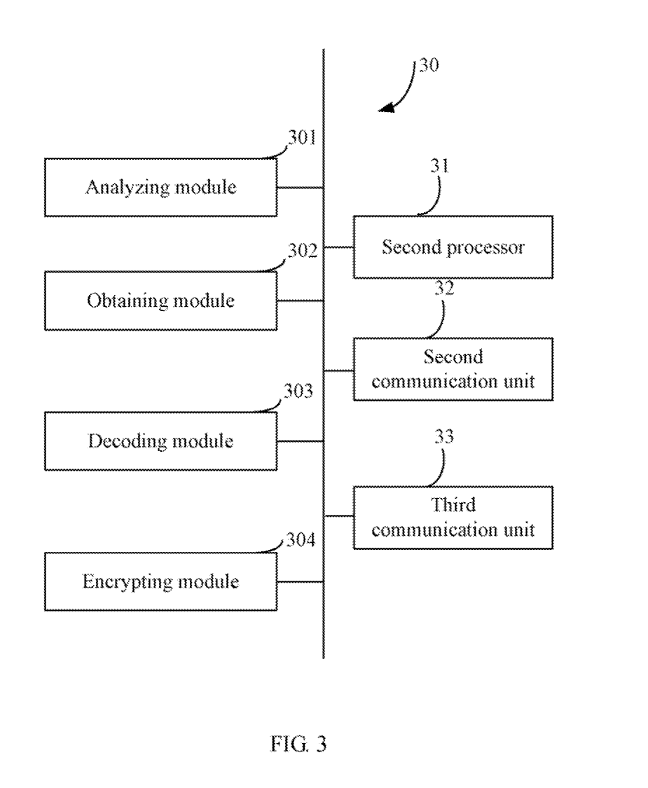

FIG. 3 shows a block diagram of the mobile device 30 in accordance with an exemplary embodiment. The mobile device 30 includes a second processor 31, a second communication unit 32, a third communication unit 33, an analyzing module 301, and an obtaining module 302. The second communication unit 32 is to communicate with the first communication unit 13 through the first network 40. The third communication unit 33 is to communicate with the internet server 20 through the second network 50.

The analyzing module 301 is operable to receive the request from the second communication unit 32, and analyze the request to obtain an internet address of the target web page. The obtaining module 302 is operable to access the target web page on the internet server 20 according to the internet address through the third communication unit 33, obtain the source code of the target web page from the internet server 20, and transmit the obtained source code through the second communication unit 32 to the first communication unit 13.

In the embodiment, the mobile device 30 further includes a decoding module 303 and an encrypting module 304. Before the analyzing module 301 analyzes the request, the decoding module 303 decodes the received request. Before the obtaining module 302 transmits the source code through the third communication 32 to the first communication unit 13, the encrypting module 304 encrypts the obtained source code.

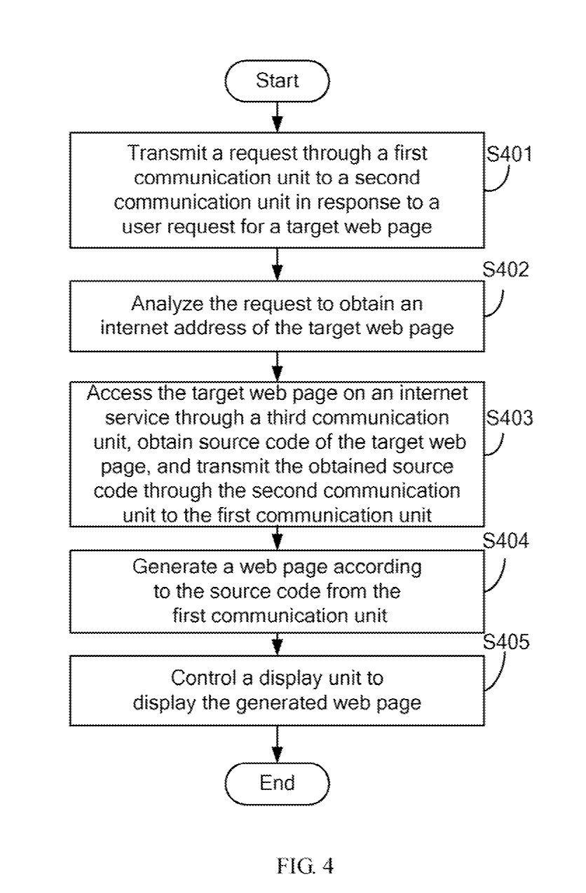

FIG. 4 shows an internet access method in accordance with an exemplary embodiment.

In step S401, the response module 101 transmits a request through the first communication unit 13 to the second communication unit 32 in response to a user request for a target web page.

In step S402, the analyzing module 301 analyzes the request from the second communication unit 32 to obtain an internet address of the target web page.

In step S403, the obtaining module 302 accesses the target web page on an internet server 20 according to the internet address through the third communication unit 33, obtains source code of the target web page from the internet server 20, and transmits the obtained source code through the second communication unit 32 to the first communication unit 13.

In step S404, the web page generating module 102 generates a web page according to the source code from the first communication unit 13.

In step S405, the display control module 103 controls the display unit 12 to display the generated web page.

In the embodiment, the procedure of determining whether a second network 50 is available is executed before the response module 101 transmits the request through the first communication unit 13 to the second communication unit 32.

In detail, the determining module 106 determines whether the second network 50 is available in response to user request for a target web page. When the second network 50 is available, the response module 101 accesses the internet server 20 through the network unit 14, to obtain the source code of the target web page. When the second network 50 is not available, the response module 101 transmits the request through the first communication unit 13 to the second communication unit 32.

In the embodiment, the step that the encoding module 104 encodes the request is executed before transmitting the request through the first communication unit 13 to the second communication unit 32, and the step that the decoding module 303 decodes the received request is executed before analyzing the request to obtain the internet address of the target web page.

In the embodiment, the step that the encrypting module 304 encrypts the source code of the target web page is executed before transmitting the obtained source code through the second communication unit 32 to the first communication unit 13, and the step that the decrypting module 105 decrypts the source code is executed before controlling the web page generating module 102 to generate a web page.

In the embodiment, the step that the adjusting module 107 adjusts the aspect ratio of the web page, or the size of the web page is executed before the procedure of controlling the display unit 12 to display the web page.

Although the present disclosure has been described on the basis of an exemplary embodiment thereof, the disclosure is not to be construed as being limited thereto. Various changes or modifications may be made to the embodiment without departing from the scope and spirit of the disclosure.

What is claimed is:

1. An internet access system comprising:
a computer comprising:
a display unit;
a first processor;
a first communication unit; and
a plurality of program modules executed by the first processor, the plurality of program modules comprising: a first communication unit, a response module, a web page generating module, and a display control module; and
a mobile device comprising;
a second processor;
a second communication unit communicating with the first communication unit through a first network;
a third communication unit communicating an internet server through a second network; and
a plurality of program modules executed by the second processor, one or more program modules comprising: an analyzing module, and an obtaining module;
wherein, the response module is operable to transmit a request through the first communication unit to the second communication unit in response to a user request for a target web page; the analyzing module is operable to analyze the request from the second communication unit to obtain an internet address of the target web page; the obtaining module is operable to access the target web page on an internet server according to the internet address through the third communication unit, obtain source code of the target web page from the internet server, and transmit the obtained source code through the second communication unit to the first communication unit; the web page generating module is operable to generate a web page according to the source code from the first communication unit; and the display control module is operable to control the display unit to display the generated web page.

2. The internet access system as described in claim 1, wherein the computer further comprises an encoding module, the mobile device further comprises a decoding module, the encoding module is operable to encode the request before the response module transmits the request through the first communication unit to the second communication unit, the decoding module is operable to decode the received request from the second communication unit before the obtaining module analyzes the request to obtain the internet address of the target web page.

3. The internet access system as described in claim 1, wherein the computer further comprises a decrypting module, the mobile device further comprises an encrypting module, the encrypting module is operable to encrypt the obtained source code of the target web page before the obtaining module transmits the source code from the second communication unit to the first communication unit, the decrypting module is operable to decrypts the received source code before the web page generating module generates the web page.

4. The internet access system as described in claim 1, wherein the computer further comprises a network unit and a determining module, the network unit communicates with the internet server through the second network, the determining module is operable to determine whether the second network is available in response to user request for a target web page, the response module is operable to access the internet server through the network unit when the second network is available, and the response module is operable to transmit the request through the first communication unit to the second communication unit when the second network is not available.

5. The internet access system as described in claim 1, wherein the computer further comprises an adjusting module, the adjusting module is operable to adjust an aspect ratio of the web page, or a size of the web page.

6. The internet access system as described in claim 1, wherein the first network is a Bluetooth network or Wi-Fi network.

7. The internet access system as described in claim 1, wherein the second network is a global system for mobile communications network, a code division multiple access network, or a third generation network.

8. An internet access method implemented by an internet access system, the internet access system comprising a computer and a mobile device, the computer comprising a first communication unit and a display unit, the mobile device comprising a second communication unit and a third communication unit, the second communication unit communicating with the first communication unit through a first network, the third communication unit communicating with an internet server through a second network, wherein the method comprises:
transmitting a request through the first communication unit to the second communication unit in response to a user request for a target web page;
analyzing the request to obtain an internet address of the target web page;
accessing the target web page on the internet server according to the internet address through the third communication unit, obtaining source code of the target web page from the internet server, and transmitting the obtained source code through the second communication unit to the first communication unit;
generating a web page according to the source code from the first communication unit; and
controlling the display unit to display the generated web page.

9. The internet access method as described in claim 8, further comprising:
encoding the request before transmitting the request through the first communication unit to the second communication unit; and
decoding the received request from the second communication unit before analyzing the request to obtain the internet address of the target web page.

10. The internet access method as described in claim 8, further comprising:
encrypting the obtained source code before transmitting the source code through the second communication unit to the first communication unit; and
decrypting the received source code before generating the web page.

11. The internet access method as described in claim 8, wherein the computer further comprises a network unit communicating with the internet server through the second network, the method further comprises:
determining whether the second network is available in response to user request for a target web page;
accessing the internet server through the network unit when the second network is available; and
transmitting the request through the first communication unit to the second communication unit when the second network is not available.

12. The internet access method as described in claim 8, further comprising:
adjusting an aspect ratio of the web page, or a size of the web page.

13. The internet access method as described in claim 8, wherein the first network is a Bluetooth network or Wi-Fi network.

14. The internet access method as described in claim 8, wherein the second network is a global system for mobile communications network, a code division multiple access network, or a third generation network.
